(19) United States
(12) Patent Application Publication
(10) Pub. No.: US 2010/0209655 A1
(43) Pub. Date: Aug. 19, 2010

(54) Refrigerator shelves and bin protectors come easy cleaners

(76) Inventor: Jennifer K. Brannan, Montezuma, GA (US)

Correspondence Address: Jennifer K. Brannan, 708 College St., Montezuma, GA, 31063, US

(21) Appl. No.: 12/378,357

(22) Filed: Feb. 13, 2009

(51) Int. Cl. B32B 3/06; B32B 3/24

(52) U.S. Cl. 428/99; 428/137

(57) ABSTRACT

The “Refrigerator Shelves and Bin Protectors come easy cleaners” are disposable semi plastic transparent material produced in three different models for domestic refrigerators and commercial freezers. These protectors come cleaners protect the refrigerator selves and bins from the spellings, food of allergies and molds. The three models 1. Grill shelves protector come cleaner, 2. Plain shelve protectors come cleaner, 3. Bin protectors come cleaners. Are designed to fit inside the refrigerator shelves and in the bins. These protectors are in built with cleaning tissue paper and cleaning gel for cleaning the shelves and the bins before fixing another new disposable bin protector come cleaner.

One day as I was cleaning my refrigerator a thought came to me about how there was an easier way to keep cleaning the shelves and bins, and it will be nice to have a plastic sheet that would fit easily inside the bins and on top of the shelving that could be disposable. Then I started experimenting with different things and finally I designed this product and using happily in my home and my product name is “Refrigerator Shelves and Bin Protector Come Easy Cleaner”. The Shelf Protector is a semi-plastic liner, designed to be used inside the refrigerator bins and on the shelving of all kind refrigerators. The plastic protectors are designed for easy cleaning, and protecting from food spills off at the beneath of the bins and shelves. This product is easy to remove and also helps keep food items sanitary. Today allergies caused by food are very high, because many kinds of bacteria alive with stored food and drinks. Once bacteria entered with food in to the refrigerator it will spread to other stored food inside the refrigerator. Sometimes this effect will not be identified with in the family members because many people have the good resistance to cold or only few have the allergy problem in the families. Many people did not notice this as problem.

The Protector's are designed to appeal to commercial restaurants apartments and condo complexes, hotels, and individual homeowners. This product is convenient for the elderly as well and college kids.

The shelve protector is easily marketed through grocery stores, kitchenware specialty stores, Internet, departmental stores, and specialty catalogs,. The protector is designed for success.

These protectors are designed basically in three different models and in different sizes according to the refrigerator design and size. In the world there are numbers of companies producing different kind of home and commercial usage refrigerators. But all the refrigerators are used for storing drinks, vegetables, fruits and other food products. These all will be placed in the refrigerator directly or with covers. But still the underneath of the shelves and bins don't have any cover to protect from dust and easy removing of leftovers in and on (like, vegetable wastage, fruit wastage, pizzas, cakes, brad, drinks, milk spilling from restaurant packages).

If you have some liter layer to have this wastage and easy to remove then it is a great help for housewives, bachelors, and restraint workers for cleaning to keep the food in good condition. Especially Families with kids need more care towards sanitation. Families with kids also will have much cleaning problems due to the lots of leftovers inside the refrigerator. The main aim of designing the “refrigerator self and bin protector” to make cleaning easy to keep sanitization up to date for our good health.

### DESCRIPTION OF DRAWINGS

These “Protectors” are designed in three types:

1. Grill shelves protector come cleaner 2. Plain shelve protectors come cleaners 3. Bin protectors come cleaners.

1. Grill shelve protectors come cleaner; is a rectangle shaped semi-plastic transparent sheet with two layers. At front side it has (1) hand grip extinction and the two layers cover seal opening (2) space. Can open this seal by inserting fingers in to the seal opening space. Then we can pull out the (3) tissue paper. This tissue paper is filled with scented liquid cleaner to clean the shelves.

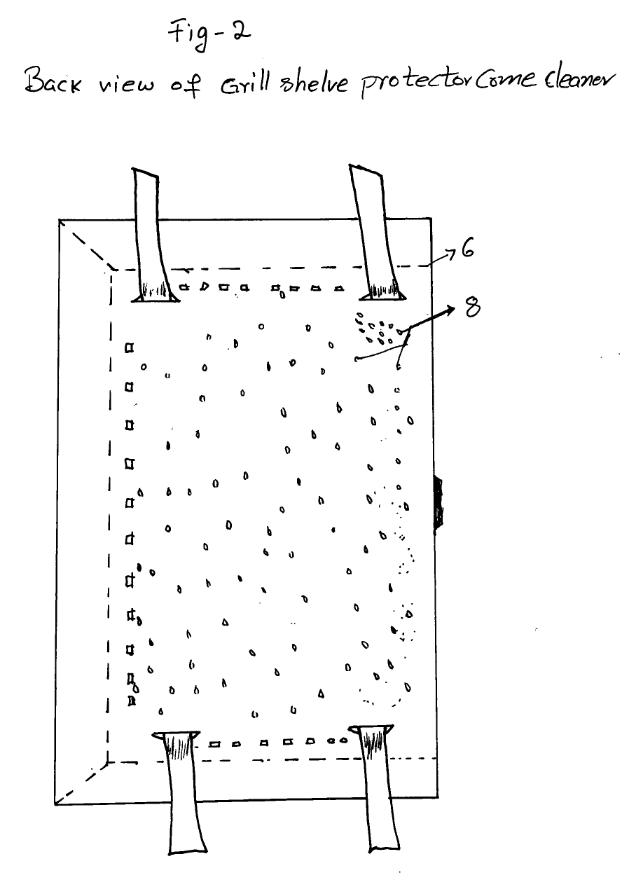

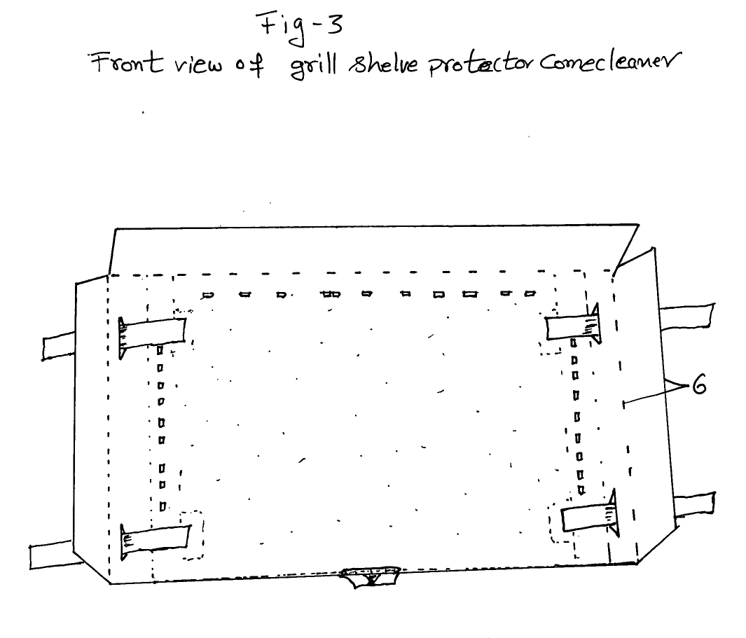

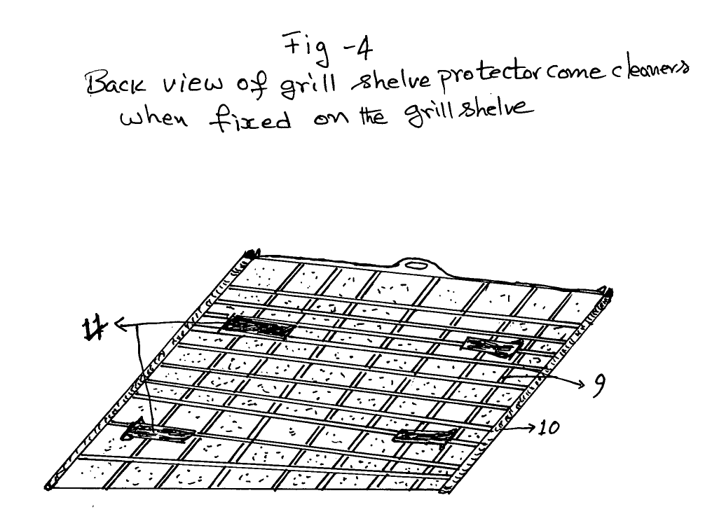

The two sides and the back side of the protector is has folding markers (7). So with the help of the markers we can fold the three sides of protector to get support in the refrigerator walls. Next to the folding marks it has four gum straps (4) these four straps are used for tightening to the selves by sticking on the bottom of the shelves. These four straps will be covered with removable non sticking papers. These papers can be removed before sticking to the shelves. The four straps can be brought down from the four strap openings (5). On the top between the four straps openings there are side ventilators (7) for air transfer. At back side (FIG. 2) it also has micro ventilators (8).

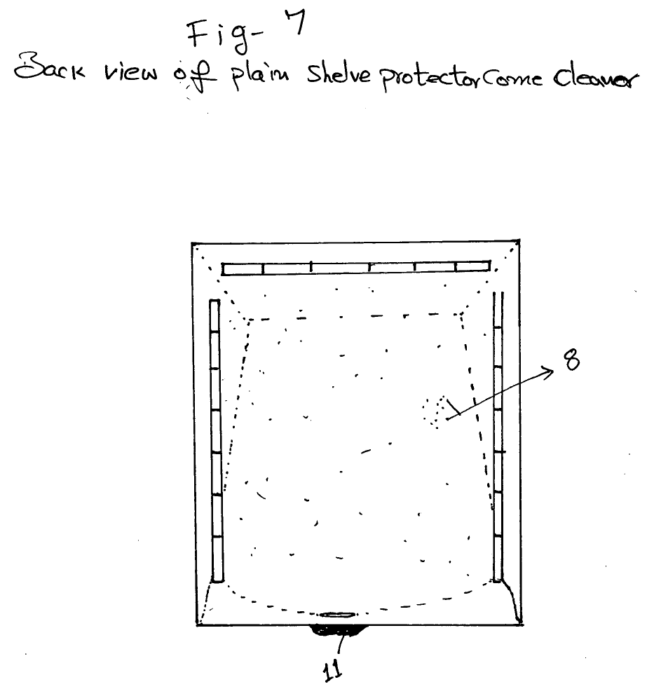

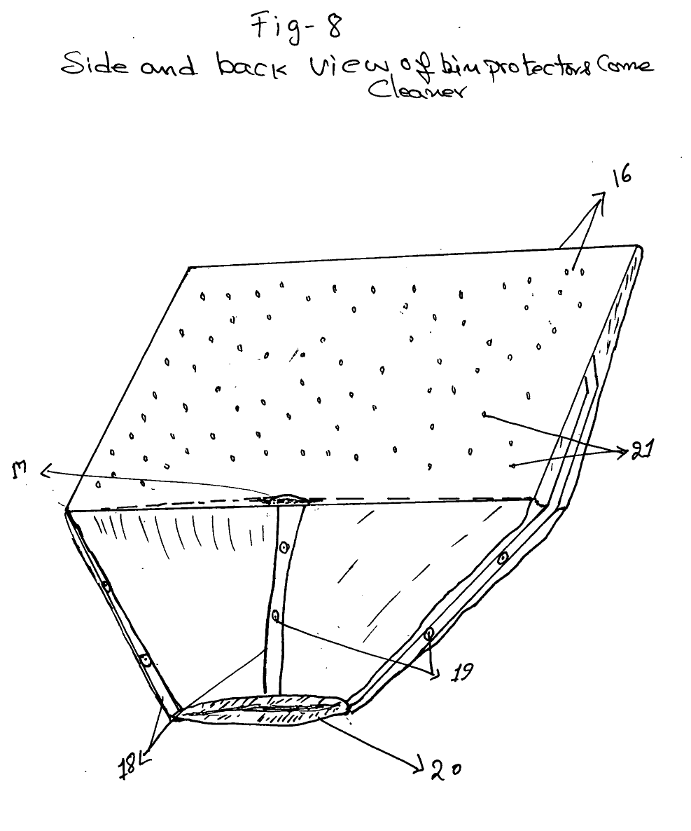

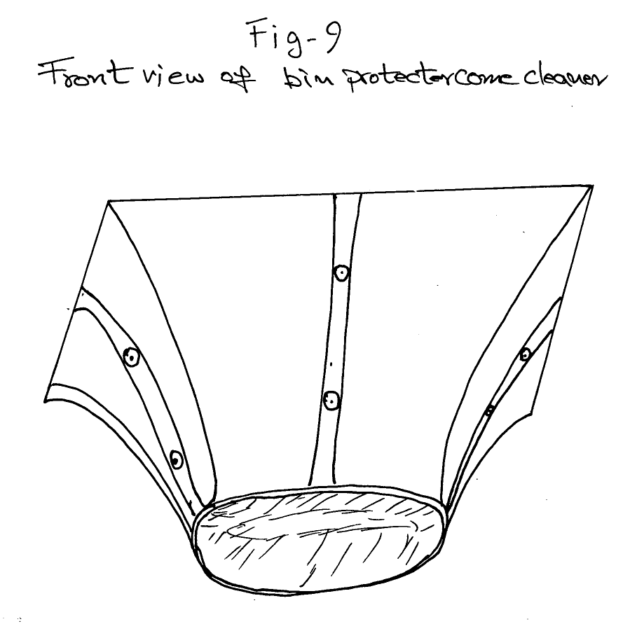

2. Plain shelf protector comes cleaner; these can be made in different sizes according to the refrigerator and these can be made with transparent semi-plastic. These are designed for refrigerator plain shelves. At front the protector has handle grip extinction (11) and next to that it has open space (14) for removing the cover seal and to pull out the tissue paper. On the top at three sides it has extended sides (12) to fix on the inner walls of the refrigerator. Next to the extinctions on the three sides it has side ventilators (13). At back side also they have (FIG. 7) micro ventilators (8).

3. Bin protectors come cleaners; Bin protectors are designed for different kind of refrigerator bins, and can be produced in different sizes. These bins can be made with the combination of polythene, plastic and rubber. The bin bag bottom is inbuilt with bottom protector (16). This bottom protector will have tissue paper with two sealed layers. To open the tissue paper the opening is outside of the bottom. This bottom is helps to fix in the bin. The bottom is extended with polythene on the four sides at the end of this polythene is attached to a elastic. This elastic is useful to fix the bin protector on the top edges of the refrigerator bins. From the elastic attachments there is a extinction layer ( ) this layer with open and closing slider ( ). This in extinction is useful to cover the top of the bin and inside the stuff. When we want to put some stuff open the cover with slider and move back the slider to close when the stuff is placed inside. Outside of the bin protector is supported by four straps ( ) at four sides. These straps are attached to the bottom and top end of the bin bag protector. Each strap has two suction cups (22) at top and bottom. These suction cups are used to fix the bin bag on the walls of the refrigerator bins.

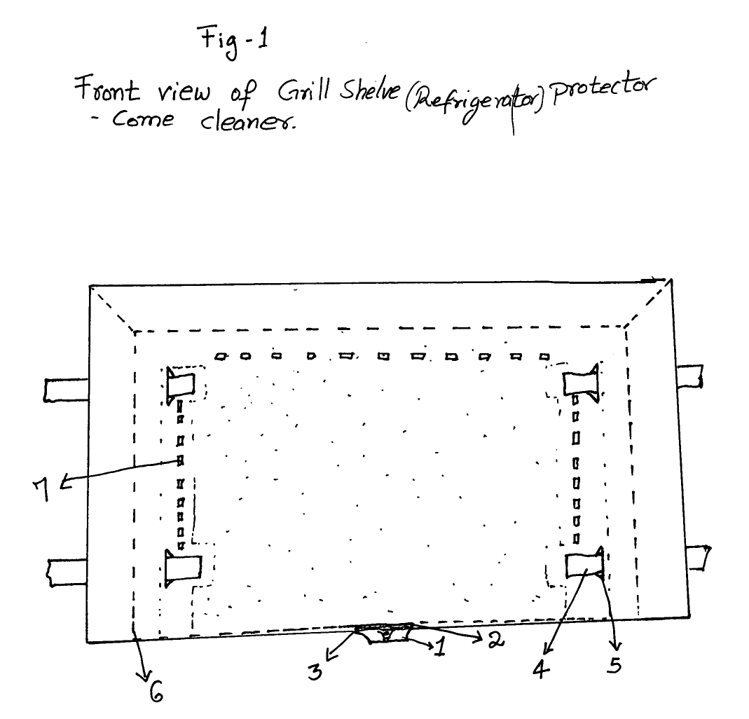

1. The Independent claim semi-plastic transparent sheet with two layers (FIG. 1) with 3 side foldable refrigerator wall fitting edges (6) and one extended hand grip (1)

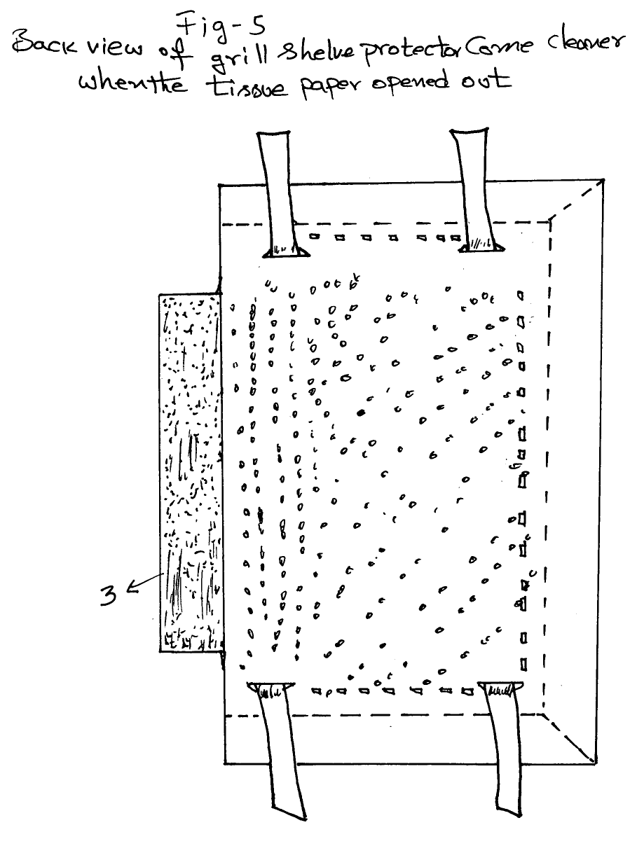

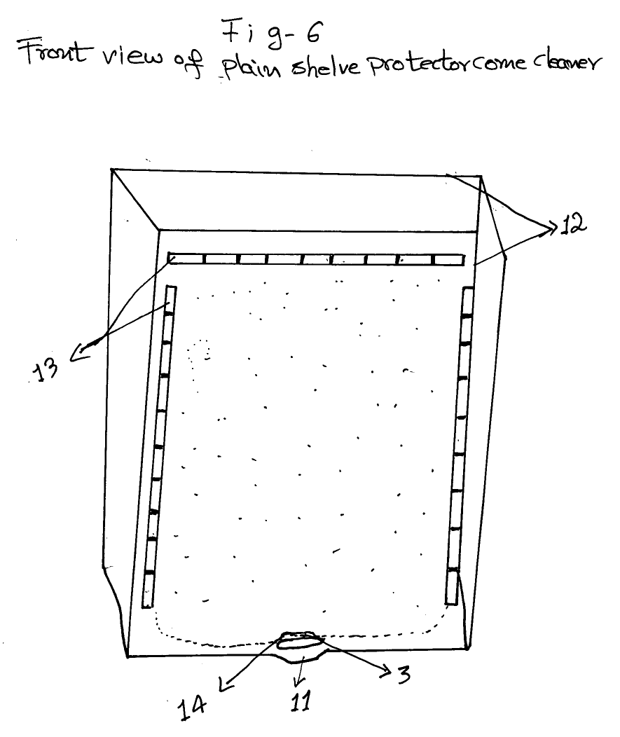

2. The dependent claim 1, the semi-plastic transparent sheet (FIG. 5) has two layers to keep

3. tissue paper (3) with cleansing lotion and had one seal opening space (FIG. 1) (2). The dependent claim 2, the semi-plastic transparent sheet has four gum straps (FIG. 1) (4) with removable non sticking paper.

4. The dependent claim 3, the semi-plastic transparent sheet on top has four strap openings (5) (FIG. 1).

5. The dependent claim 4, the semi-plastic transparent sheet on top has ventilators (7), (FIG. 1), micro ventilators 8 at bottom (FIG. 2)

6. The Independent claim 2, the semi-plastic transparent sheet with two layers has three side extended wall fitting edges (12) (FIG. 6).

7. The dependent claim 1, the two layered semi-plastic transparent sheet has ventilator (13) on top (FIG. 6) and has micro ventilators (8) on bottom layer (FIG. 7)

8. The dependent claim 2, the two layered semi-plastic transparent sheet has one seal opening space (14) (FIG. 6) to pull out tissue paper with cleaning lotion (3), (FIG. 6).

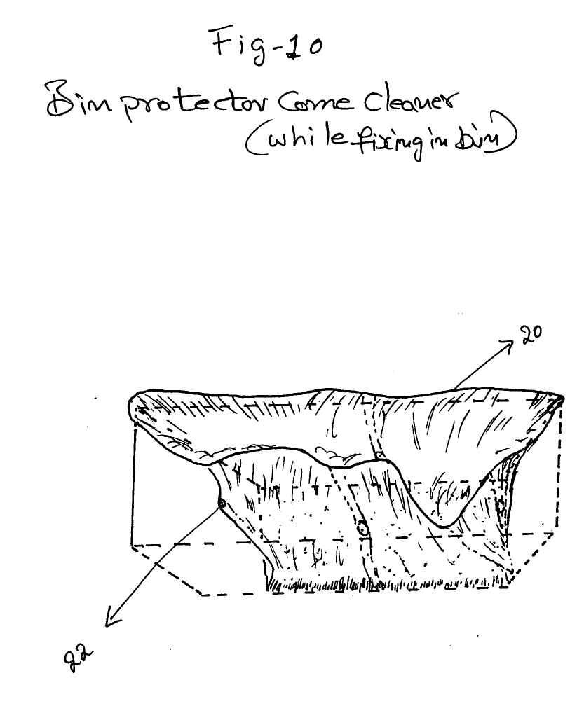

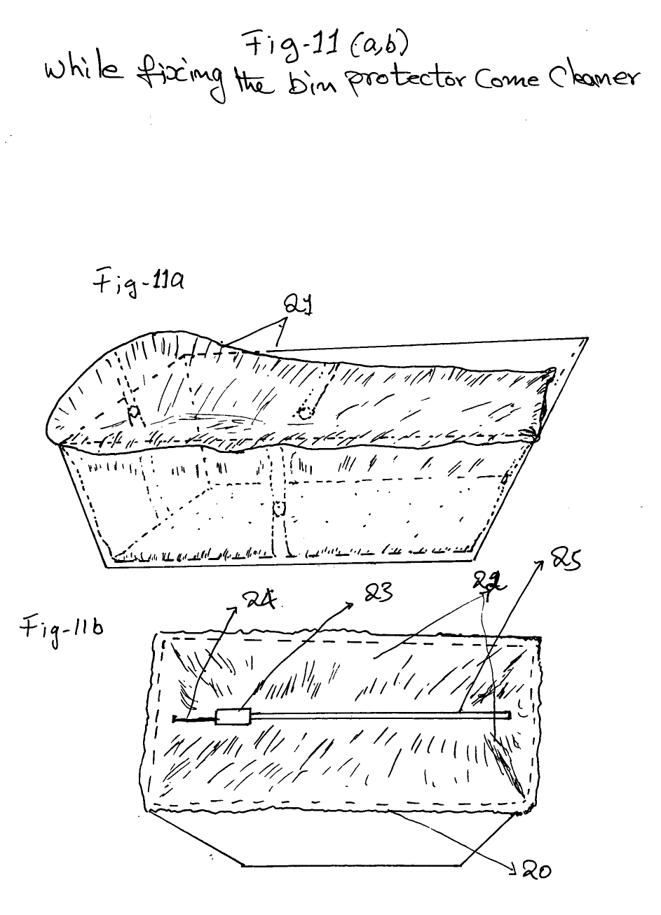

9. The independent claim 3, the transparent semi-plastic cover has bottom (16) (FIG. 8) with two sealed layers and with opening space (17) to pull out tissue paper.

9. The dependent claim 1, the transparent semi-plastic cover has elastic (20), (FIG. 8) to fix on refrigerator bins.

10. The dependent claim 2, the transparent semi-plastic cover has supporting straps (18), (FIG. 8) on four sides of the bin protecting cover.

11. The dependent claim 3, of 2 has suction cups (19), on supporting straps (18), (FIG. 8) to fix on inner walls of the refrigerator bins or commercial deep freezers.

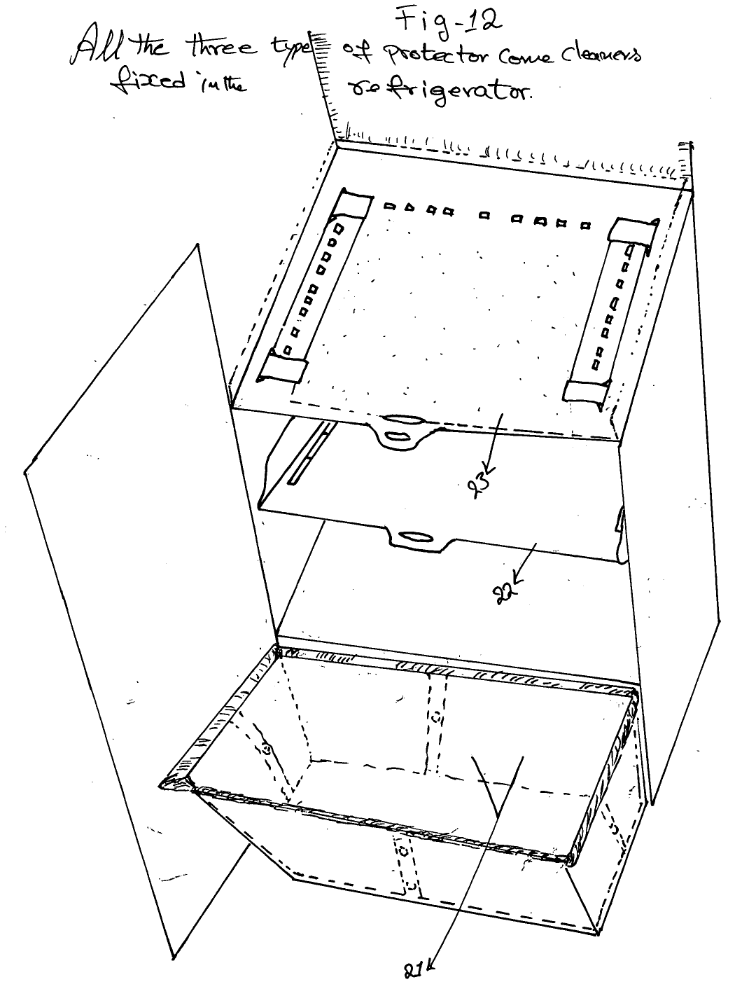

12. The dependent claim 4, the transparent semi-plastic cover has top sealing (22) with opening and closing slider (23) (FIG. 11-b).
